(19) United States
(12) Patent Application Publication
(10) Pub. No.: US 2023/0245452 A1
(43) Pub. Date: Aug. 3, 2023

(54) ADAPTIVE MULTIMODAL EVENT DETECTION

(71) Applicant: Intel Corporation, Santa Clara, CA (US)

(72) Inventors: Say Chuan Tan, Pulau Pinang (MY); Mee Sim Lai, Pulau Pinang (MY); Ying Wei Liew, Gelugor (MY); Chien Chern Yew, Geortown (MY); Kuan Heng Lee, Air Itam (MY); Nicolas C. Galoppo von Borries, Portland, OR (US); Rita Chattopadhyay, Chandler, AZ (US)

(73) Assignee: Intel Corporation, Santa Clara, CA (US)

(21) Appl. No.: 18/131,783

(22) Filed: Apr. 6, 2023

(51) Int. Cl. G06V 20/40; G06V 20/52

(52) U.S. Cl. CPC G06V 20/44; H04N 23/667; G06V 20/52; H04N 23/695

(57) ABSTRACT

Embodiments of adaptive multi-modal event detection are disclosed herein. In one example, sensor data captured by multiple sensors is received, and an inconsistency among the sensors is detected based on performing event detection on the sensor data. An external environment of the sensors is detected based on the sensor data, and one or more configuration parameter(s) for event detection are adjusted based on the external environment of the sensors. Event detection is then performed on the sensor data based on the adjusted configuration parameter(s).

### BACKGROUND

Multimodal event detection involves the use of data from multiple modalities (e.g., video, audio) to detect events. For example, an event may be triggered if it is detected by more than one of the modalities. This approach can result in false negatives, however, as some events may not be triggered due to inconsistencies among the modalities, such as when an event is detected by some modalities but not others.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures.

FIG. 1 illustrates an example processing pipeline for performing adaptive multimodal data analytics in accordance with certain embodiments.

FIG. 2 illustrates an example implementation of an adaptive multimodal event detection system in accordance with certain embodiments.

FIG. 3 illustrates a hash table data structure for storing sensor metadata in accordance with certain embodiments.

FIG. 4 illustrates a decision tree data structure for efficiently searching the event detection status of different sensors in accordance with certain embodiments.

FIGS. 5A-B illustrate an example of a smart city surveillance use case where adaptive multimodal event detection is used to detect fighting.

FIG. 6 illustrates a flowchart for performing multimodal event detection in accordance with certain embodiments.

FIG. 7 illustrates an overview of an edge cloud configuration for edge computing.

FIG. 8 illustrates operational layers among endpoints, an edge cloud, and cloud computing environments.

FIG. 9 illustrates an example approach for networking and services in an edge computing system.

FIG. 10A provides an overview of example components for compute deployed at a compute node in an edge computing system.

FIG. 10B provides a further overview of example components within a computing device in an edge computing system.

FIG. 11 illustrates an example software distribution platform to distribute software.

### EMBODIMENTS OF THE DISCLOSURE

In a multimodal data fusion scenario for event detection, multiple sources of input data from different modalities (e.g., video, audio, and/or other sensor data) are typically fused together to provide a more comprehensive picture for detecting events of interest (EOIs). A system typically has a predefined way to detect events based on the respective modalities. In some cases, for example, an EOI may be triggered when more than one modality detects an event with the same or similar level of confidence and reliability. Current solutions suffer from false negatives, however, as an EOI may not be successfully triggered if some modalities are given more weight than others and/or the modalities are inconsistent or otherwise contradict each other.

As an example, in an audio/visual multimodality for fight detection, audio and video modalities are fused together to detect fighting events using sound classification and action recognition computer vision modules. In some cases, the audio modality may detect a fighting event, while the video modality detects no activity because the fighting event is outside the current field of view of the camera. As a result, certain events may be ignored due to the uncertainty and/or inconsistency among the modalities.

Thus, while the use of multiple modalities improves complementarity and diversity, it also creates uncertainty in real-world settings, which leads to undesired data fusion quality when the underlying relationship between modalities is not properly understood and/or defined.

Accordingly, this disclosure presents embodiments of adaptive multimodal event detection, where the configuration used for event detection is dynamically adapted in real time based on external factors, such as environmental conditions or other external considerations. In some embodiments, for example, when there are inconsistencies among different modalities or sensors used for event detection (e.g., an event is detected by some sensors but not others), external factors detected by the sensors may be used to adjust various configuration parameters in real time to enhance the consistency and reliability of the event detection results among the sensors. For example, based on the external factors, the weights used to fuse the respective modalities may be adjusted, the sensors or other modalities used for data ingestion may be reconfigured, and/or the workloads used to perform event detection based on data from the respective modalities may be reconfigured.

The described solution provides various advantages. For example, the described solution intelligently combines/fuses multiple data sources or modalities to provide more accurate, consistent, and concise analytics than any individual data source.

The described solution is also beneficial for edge computing, as it enables multimodal artificial intelligence applications to be deployed and/or distributed at the edge with improved performance. In particular, the described solution works well with Internet-of-Things devices, which are often equipped with a variety of sensors that capture large amounts of data. The workloads of multiple sensors, such as deep learning inference on visual and audio data, may be consolidated on a single edge device with heterogenous processing resources, such as a central processing unit (CPU), graphics processing unit (GPU), vision processing unit (VPU), field-programmable gate array (FPGA), and so forth. As a result, large volumes of data can be processed accurately and efficiently at the edge instead of being funneled to the cloud, which results in cost savings and also enables deployments that would otherwise be infeasible due to limited network bandwidth and real-time constraints of many applications.

The described solution is applicable to a variety of use cases that rely on data from multiple modalities for event detection or other types of data analytics, particularly when real-time corrective action must be taken in certain situations. These use cases span a variety of industries and market segments, including automotive, aerospace, manufacturing and industrial (e.g., robotic safety, quality control, anomaly detection), smart cities (e.g., public safety and surveillance), retail (e.g., personalized shopping experience, frictionless store, customer service quality evaluation, etc.), education (e.g., smart classrooms, school safety and surveillance), business (e.g., smart meeting rooms), augmented reality and/or virtual reality (AR/VR), and more.

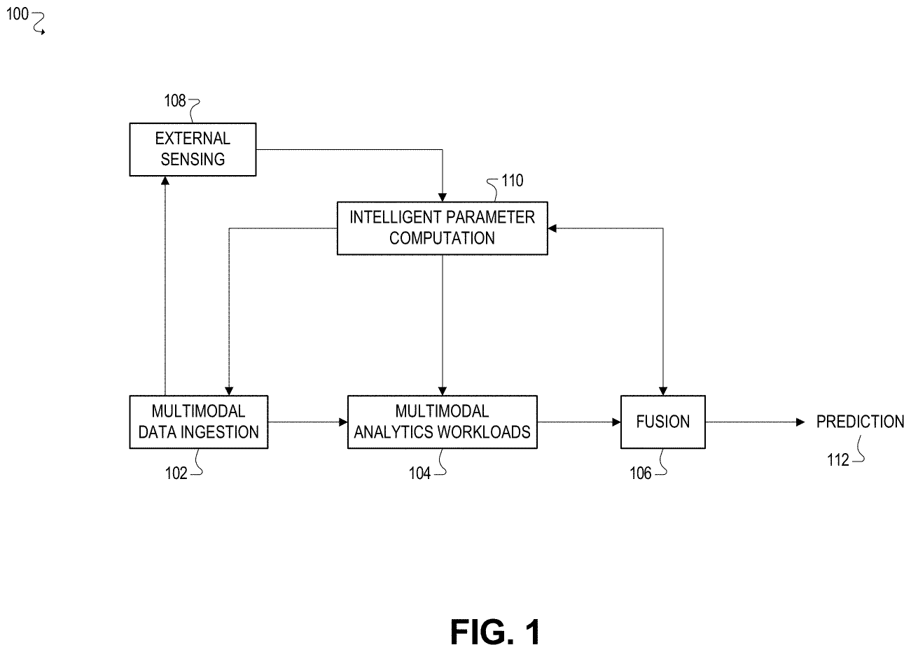

FIG. 1 illustrates an example processing pipeline 100 for performing adaptive multimodal data analytics in accordance with certain embodiments. In various embodiments, the functionality of pipeline 100 may be implemented on a single compute node or may be distributed across multiple compute nodes in a distributed computing infrastructure.

The pipeline 100 begins with multimodal data ingestion 102, where input data is continuously captured and ingested from multiple sensors or other modalities, such as cameras, microphones, LIDAR, and so forth. In some embodiments, various types of preprocessing may be performed on the input data before further analysis, such as filtering, cleaning, denoising, reformatting, and so forth.

The (preprocessed) input data is then provided as input to the multimodal analytics workloads 104, which are used to perform analytics on the data from the respective modalities or sensors, such as event detection or any other form of analytics (e.g., classification, regression, inference, predictive analytics, etc.).

In some embodiments, for example, event detection may be performed on the data from each modality using artificial intelligence (e.g., deep learning models) and/or other forms of statistical analysis or analytics. Further, in some embodiments, data from each modality may be processed by a separate event detection workload. For example, each workload may perform event detection on data from one of the modalities, such as video/images from cameras, audio from microphones, or point clouds from LIDAR. Further, the output of the workload for each modality may indicate a confidence level or probability of an event occurring.

The output of each workload/modality (e.g., confidence/probability) is then provided to the fusion block 106, which generates a final prediction 112 by fusing the outputs from the respective workloads/modalities. For example, with respect to event detection, a weighted average of the confidence levels output by the respective modalities may be computed, and if the weighted average is above a threshold (e.g., 80%), an event may be triggered.

In some cases, however, there may be inconsistencies in the outputs from different modalities. For example, an event may be detected with high confidence by some modalities/sensors and not others, or the confidence level of a detected event may vary significantly among the modalities/sensors. As a result, the fused prediction result 112 may have a low confidence level that falls below the threshold or within certain boundary conditions, which creates uncertainty as to whether the event of interest actually occurred. In these cases, external conditions of the environment may be used to dynamically adjust the system configuration in real time to achieve greater consistency and balance among the outputs of the respective modalities, thus improving the confidence level and reliability of the fused prediction 112.

For example, external sensing 108 may be performed to detect conditions of the surrounding environment based on data from sensors or other sources, such as time of day/night, lighting, weather, visibility, noise, location of sensors, location/direction of potential events or activity, and so forth.

Based on the detected external conditions, intelligence parameter computation 110 is then performed to achieve more consistent and reliable predictions among the respective modalities, thus improving the overall accuracy of the fused prediction 112. For example, intelligence parameter computation 110 dynamically reconfigures the system in real time based on the external conditions, including:
(i) reconfiguring the sensors or other modalities used for data ingestion (e.g., the camera frame rate, resolution, lighting, or field of view; the microphone sampling rate, sensitivity, or beam direction);
(ii) reconfiguring the computational workloads used to perform event detection for the respective modalities (e.g., performance adjustments, dynamic inference model switching); and/or
(iii) tuning the weights used to fuse the respective modalities (e.g., giving more weight to modalities that are more reliable in the current conditions).

The data ingestion inputs, workloads, and/or data fusion weights will be continuously tuned in this manner until more consistency and balance is achieved among the modalities. This intelligence helps improve the overall accuracy of the fused prediction 112 for a potential event-of-interest so that a genuine event will not be missed or neglected.

In the illustrated embodiment, the respective modalities are fused using decision-level fusion, where the fusion is performed on the respective predictions/results of the multimodal workloads 104. In other embodiments, however, the modalities may be fused using other approaches, including data-level fusion (e.g., fusing the input data from each modality), feature-level fusion (e.g., extracting features from the input data of multiple modalities), and so forth.

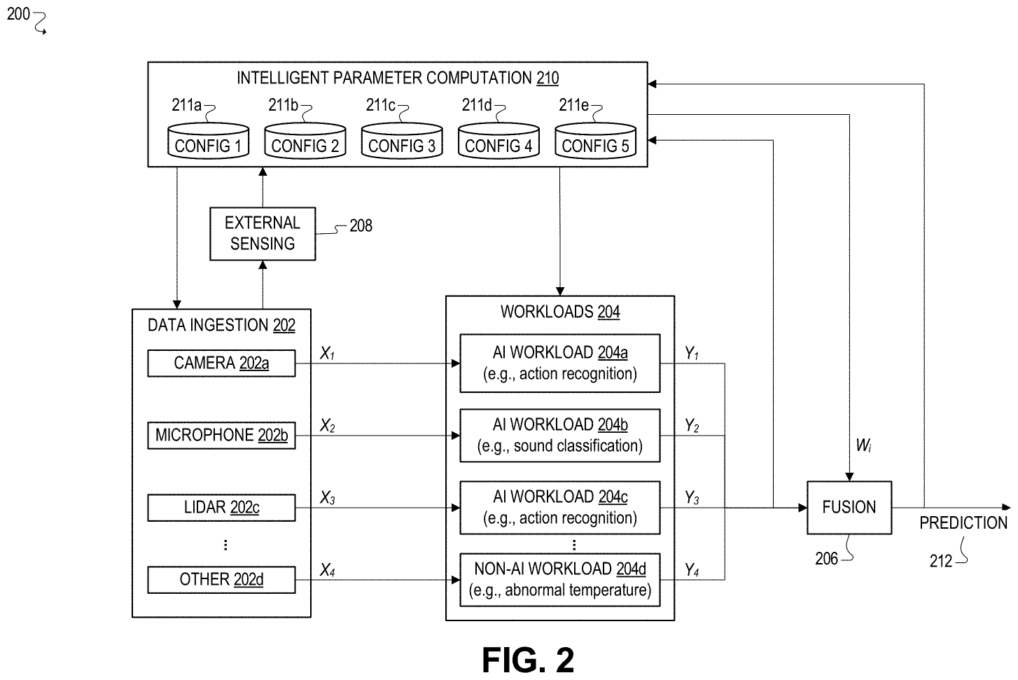

FIG. 2 illustrates an example implementation of an adaptive multimodal event detection system 200 in accordance with certain embodiments. In various embodiments, the functionality and components of system 200 may be implemented on a single compute node or may be distributed across multiple compute nodes in a distributed computing infrastructure.

In the illustrated embodiment, system 200 includes data ingestion inputs 202a-d, event detection workloads 204a-d, fusion logic 206, external sensing logic 208, and intelligent parameter computation logic 210.

The data ingestion inputs 202 include a camera 202a, microphone 202b, LIDAR 202c, and potentially other sensors, modalities, or data sources 202d (e.g., thermometer/temperature sensor, gas sensor, clock). Each data ingestion input 202a-d generates a stream of raw data, where Xᵢ represents the raw data from modality i, such as video (X₁) from the camera 202a, audio (X₂) from the microphone 202b, point clouds (X₃) from LIDAR 202c, and any other type of data (X₄) from other modalities 202d in the system 200.

Each data stream Xᵢ is analyzed separately through independent event detection workloads 204a-d, some of which may leverage artificial intelligence (AI) techniques (e.g., deep learning) and others that may leverage other forms of analytics. For example, the video data X₁ may be analyzed using an AI workload 204a that performs object detection and/or action recognition, the audio data X₂ may be analyzed using an AI workload 204b that performs sound classification, the LIDAR point cloud data X₃ may be analyzed using an AI workload 204c that performs object detection and/or action recognition, and other data X₄ may be analyzed using non-AI workloads 204d (e.g., detecting an abnormal temperature from a temperature sensor, detecting the presence of a certain type of gas from a gas sensor). Further, the output of the workload 204a-d for each modality may indicate a confidence level or probability of an event occurring, where Y represents the output of the workload for modality i.

The fusion logic 206 then computes a fused prediction 212 by fusing the outputs Yᵢ of the workloads 204a-d for each modality. For example, with respect to event detection, the fused prediction 212 may be a weighted average of the confidence levels output by the respective modalities, Σᵢ₌₁^{N}(WᵢYᵢ), where:
i represents a numerical identifier assigned to each modality (e.g., i=1 . . . N for N modalities);
Yᵢ represents the output of the workload 204 for modality i (e.g., the confidence level of an event output by vision-based action recognition 204a, sound classification 204b, etc.); and
Wᵢ represents the dynamic weight applied to the output (Yᵢ) of modality i for the fused prediction 212 (e.g., where Wᵢ is determined based on external sensing 208 and intelligent parameter computation 210).

In some embodiments, an event may be formally detected or triggered if the fused confidence level 212 is above a threshold (e.g., 80% or higher).

In some cases, however, there may be imbalance or inconsistency in the outputs Yᵢ of the respective modalities. For example, an event may be detected with high confidence by some modalities/sensors and not others, or the confidence level of an event may fluctuate or vary significantly among the modalities/sensors (e.g., an audio modality has high confidence of an event while a video modality has low confidence of the event because the event is outside the field of view of the camera). As a result, the fused prediction 212 may have a low confidence level that falls below the event trigger threshold and/or within certain boundary conditions, which creates uncertainty as to whether the event of interest actually occurred.

Due to this uncertainty, external conditions of the environment may be used to dynamically reconfigure the system 200 in real time to achieve greater consistency and balance among the outputs Yᵢ of the respective modalities, thus improving the accuracy and reliability of the fused prediction 212.

For example, external sensing 208 may be performed to detect external factors or conditions of the environment based on data from sensors or other sources 202a-d, such as time of day/night, lighting, weather, visibility, noise, location of sensors, location/direction of potential events or activity, and so forth. In particular, the accuracy of the sensing by the sensors 202a-d (e.g., cameras, microphones, LIDAR, temperature sensors, gas sensors, etc.) is highly dependent on the installation and configuration of the sensors (e.g., at the corner, wide open space, etc.) and external environmental factors (e.g., lighting conditions, weather, noisiness, etc.). The external sensing logic 208 senses the dynamic change in these external factors, such as video brightness (e.g., due to shadows, time of day/night, etc.), obstructions/occlusions in the camera field of view, noise level (e.g., based on audio input gain, audio input beaming direction), and so forth.

The installation/configuration of the sensors and the real-time changing external environmental factors are fed into the intelligent parameter computation (IPC) logic 210, along with the outputs Yᵢ of the respective modalities and the fused output 212. In this manner, if the IPC logic 210 detects an inconsistency among the modalities/sensors (e.g., based on the modality outputs Yᵢ and/or the fused output 212), it dynamically reconfigures the system 200 in real time based on the information from the external sensing logic 208.

For example, based on the external environmental conditions and sensor configurations, the IPC logic 210 may dynamically adjust the data ingestion inputs, computational workloads, and/or data fusion weights to achieve greater consistency and balance among the outputs Yᵢ of the respective modalities, thus improving the accuracy and reliability of the fused prediction 212.

For example, the data ingestion inputs may be adjusted via the internal configuration parameters and/or external actuators of the sensors, such as adjusting the pan, tilt, or zoom setting(s) of a camera to redirect the field of view of the camera, adjusting the frame rate, video resolution, or lighting intensity of the camera, adjusting the sampling rate, gain/sensitivity, or beam direction of a microphone, and so forth.

Reconfiguring the workloads 204a-d may include dynamic inference model switching, workload performance adjustments, workload prioritization, and so forth. For example, with dynamic inference model switching, the inference model used to perform a particular workload 204a-d may be switched with another model that is tuned for the current combination of environmental factors (e.g., a model trained to perform action recognition at night). Similarly, the precision of the inference engine for a particular workload 204a-d may be adjusted based on the environment (e.g., to single-precision floating-point (FP32), half-precision floating-point (FP16), and/or 8-bit integer quantization) to adjust certain performance characteristics of the workload, such as prediction accuracy, power consumption, latency, throughput, and so forth. Certain workloads may also be prioritized over others with respect to precision/accuracy, bandwidth, sampling rate, inference speed, and so forth. Further, the various workload adjustments may be performed such that the overall system resource utilization remains within the ideal operating range that the system can handle (e.g., CPU utilization <90%).

The weights Wᵢ used to fuse the outputs Yᵢ of the respective modalities may also be dynamically tuned based on the current environment (e.g., lighting, ambient noise). For example, the weights may be adjusted to increase reliance on certain modalities that are more reliable than others in the current conditions (e.g., rely more on audio/LIDAR, and less on video, at night when lighting is poor). In some embodiments, for example, a set of weights can be trained using multiple datasets under several environmental conditions that are representative of a real-world deployment scenario. In this manner, the respective modalities are no longer fused using a fixed or predetermined methodology. Rather, the weightage used to fuse the modalities is very flexible, as the weights are dynamically determined in real time based on the current external factors to improve the accuracy of the fused output 212. However, some or all of the weights can be predetermined or fixed according to the needs and requirements of a particular use case.

In some embodiments, the IPC logic 210 may include a set of predefined configurations 211a-e tailored to different deployment scenarios and environmental conditions, which may be used to make the appropriate configuration adjustments based on the current system configuration and environmental conditions. For example, when the IPC logic 210 detects an inconsistency among the modalities, it triggers a search for a new configuration that will potentially resolve the inconsistency to improve the accuracy of the fused prediction 212 for an event-of-interest. An appropriate course of action will be applied based on the sensed environmental factors, such as reconfiguring the data ingestion inputs 202a-d (e.g., sensors), reconfiguring the event detection workloads 204a-d, and/or tuning the weights Wᵢ used to fuse the modalities. Further, because the decision methodology is aimed at resolving the conflict and inconsistency among the modalities, adaptation priority may be given to modalities with lower confidence levels rather than those with higher confidence levels.

As an example, if a microphone detects fighting noises with high confidence while a camera detects fighting activity with low or zero confidence, adaptation priority may be given to the camera. Further, it may be determined that the current field of view of the camera is pointing in a different direction than where the fighting noises detected by the microphone are coming from. As a result, the pan, tilt, and/or zoom settings of the camera may be adjusted to redirect the camera field of view to the same direction where the fighting noises are coming from.

The IPC logic 210 may continue making these dynamic configuration adjustments until more consistency is achieved among the outputs (e.g., confidence levels) of the respective modalities. For example, after adjusting the configuration, the IPC logic 210 may reevaluate the outputs Y of the respective modalities and the fused output 212 to determine whether an event should be triggered, whether a potential event was a false alarm, or whether to continue making performance adjustments due to unresolved inconsistencies among the sensors/modalities.

To illustrate, consider an example of dynamic weight tuning for a system with two modalities: a camera and a microphone. Under normal environmental conditions (e.g., average brightness), the dynamic weights are evenly distributed across the modalities, W₁=W₂=0.5, where:
W₁ represents the weight for action recognition using the camera modality;
W₂ represents the weight for sound classification using the microphone modality; and
W₁+W₂=1.

Each modality generates a confidence level (e.g., 0-100%) for a particular prediction, such as whether an event such as fighting occurs, where:
Y₁ represents the confidence level for fighting from action recognition using the camera modality; and
Y₂ represents the confidence level for fighting from sound classification using the microphone modality.

In order to detect fighting, the probability of a fight from each modality is fused using a weighted average, W₁*Y₁+W₂*Y₂, and if the fused probability exceeds a threshold such as 80%, fighting is detected.

Table 1 shows example outputs for fight detection in different environmental conditions before and after the weights have been tuned. As shown by these examples, when the event detection outputs of the modalities are inconsistent, the weights of the modalities can be tuned based on the current environment to improve the confidence and accuracy of the fused output.

TABLE 1
Example of dynamic weight tuning

| | | Modality | | | | |
|---|---|---|---|---|---|---|
| | Environmental | Fusion | Modality | Fused | Fight | Actual |
| # | Conditions | Weights | Outputs | Output | Detected? | Fight? |
| 1 | bright light | W₁ = 0.5 | Y₁ = 30% | 25% | No | No |
| | | W₂ = 0.5 | Y₂ = 20% | | | |
| 2 | bright light | W₁ = 0.5 | Y₁ = 95% | 87.5% | Yes | Yes |
| | | W₂ = 0.5 | Y₂ = 80% | | | |
| 3 | low light | W₁ = 0.5 | Y₁ = 10% | 50% | No | Yes |
| | | W₂ = 0.5 | Y₂ = 90% | | | |
| 4 | low light | W₁ = 0.1 | Y₁ = 10% | 82% | Yes | Yes |
| | | W₂ = 0.9 | Y₂ = 90% | | | |

In examples 1-3 of Table 1, each modality has the same default weight (e.g., 0.5). In examples 1 and 2, under bright light conditions, the outputs of the modalities are relatively consistent (and accurate), as their respective confidence levels for fighting are either both low or both high. This is because the camera has good visibility under bright light conditions.

In example 3, under low light conditions, the outputs of the modalities are inconsistent, as the video modality has a confidence level of 10% for fighting while the audio modality has a confidence level of 90% for fighting. This is because the camera has poor visibility under low light conditions, while the microphone is unaffected by lighting. As a result, the fused output only has a confidence level of 50% for fighting, which is below the 80% threshold, and thus the system fails to detect genuine fighting.

In example 4, due to the inconsistency between the camera and microphone modalities in example 3, the weights are dynamically tuned for the low light environment. In particular, since the camera has poor visibility in low light and the microphone is unimpacted by light, the camera weight (W₁) is decreased to 0.1 and the microphone weight (W₂) is increased to 0.9, which places more weight or reliance on sound recognition compared to action recognition. As a result, the fused output has a confidence level of 82% for fighting, which is above the threshold, and thus the system successfully detects fighting.

In the example above, only one class of event is detected—fighting—which is reflected by the fact that Y and W are scalar values. However, this solution naturally extends to detection of multiple types of events concurrently, such as fighting, running, and so forth. When detecting multiple events, the output of each modality (Yᵢ) can be represented as a multi-dimensional vector of confidence values. For example, Y₁=[0.1, 0.4] may represent the output of action recognition on a video stream for “fighting” and “running” events, where the confidence level of “fighting” is 10% and the confidence level of “running” is 40%. The fused output may similarly be represented as a multi-dimensional vector of confidence values, where an output of [0.82, 0.43] means the overall confidence level for “fighting” is 82% and the overall confidence level for “running” is 43%. In some embodiments, the confidence levels may be sorted and the event with the highest confidence may be evaluated as the most likely event.

This solution is flexible and the data fusion logic can remain very light even as more modalities are added. For example, when the confidence of a particular modality is extremely high, this solution may focus primarily or exclusively on that modality in some situations, and the other modalities may be ignored or temporarily deactivated. As a result, the other modalities do not increase the burden or load on the system.

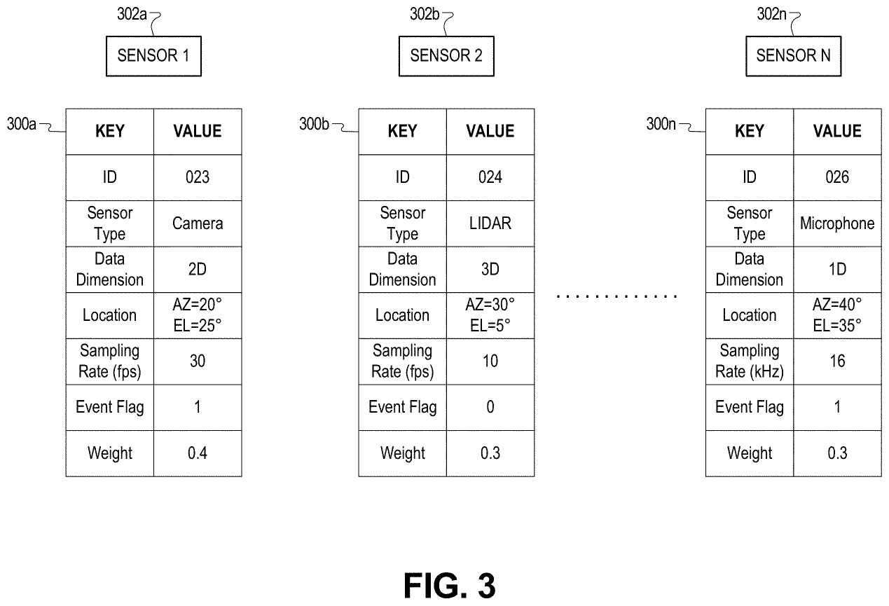

FIG. 3 illustrates an example of a hash table data structure for storing sensor metadata in accordance with certain embodiments. In some embodiments, for example, the hash table data structure may be used to store metadata for each sensor used in an adaptive multimodal event detection system.

In the illustrated example, each sensor 302a-n has an associated hash table 300a-n that stores various attributes in the form of key-value pairs, including a unique identifier (ID), sensor type (e.g., camera, LIDAR, microphone), data dimensionality (e.g., 1D, 2D, 3D), location (e.g., absolute location such as GPS coordinates, relative location such as a floor or room of a building, etc.), sampling rate, event detection flag, and default weight for fusion. It should be appreciated that these attributes are merely provided as examples, and additional or alternative attributes may be provided in other embodiments, such as sensor orientation, direction, or field of view, confidence level or probability associated with the event detection flag, and so forth.

In this manner, the metadata or attributes of each sensor 302a-n can be accessed by looking up the values for the respective keys in the hash table 300a-n associated with the particular sensor. For example, the event detection flag can be accessed to determine if an event is currently being detected based on the data captured by a particular sensor. Similarly, the default weight for each sensor can be accessed to fuse the sensor data and/or event detection results of the respective sensors.

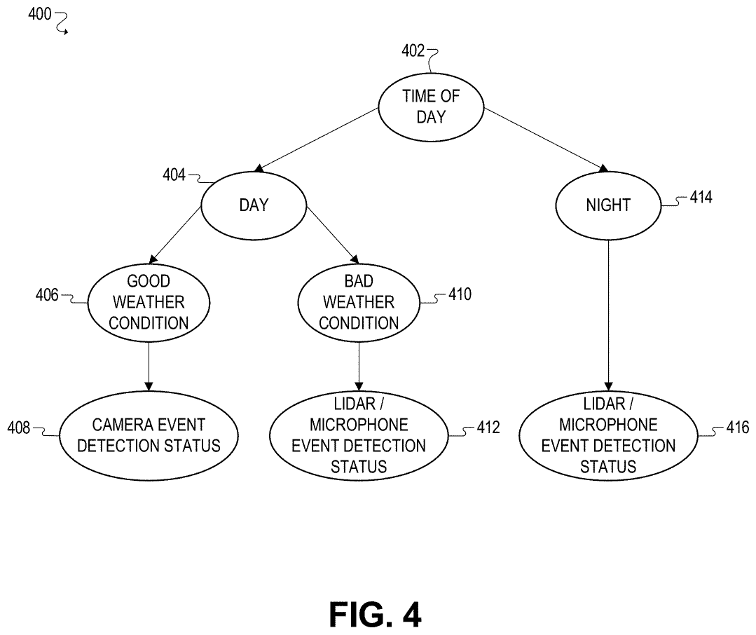

FIG. 4 illustrates a decision tree data structure 400 for efficiently searching the event detection status of multiple sensors in accordance with certain embodiments. For example, in a system with numerous sensors, performing a linear search of the event detection flag in the hash tables 300a-n of the respective sensors 302a-n can be inefficient. Thus, in some embodiments, a decision tree 400 may be used to efficiently check which sensors generated an event detection alert, assign/update the weight and configuration parameters of the sensors per the intelligent parameter computation block, and so forth. In particular, the decision tree 400 enables the event detection status of the most relevant or reliable sensors to be checked first based on the current environmental conditions detected by the sensors (e.g., time of day, lighting, weather, etc.).

In the illustrated example, the decision tree 400 begins by determining the time of day 402. If it is currently daytime 404, the decision tree 400 determines whether the weather is good 406 or bad 410. If the weather is good 406, the event detection status of the camera is checked 408 since it is usually reliable when visibility is good (e.g., due to daylight and clear skies). If the weather is bad 410, the event detection status of LIDAR and the microphone are checked 412 since they are usually more reliable than the camera when visibility is poor (e.g., due to bad weather). Similarly, if it is currently nighttime 414, the event detection status of LIDAR and the microphone are checked 416 since they are usually more reliable than the camera when visibility is poor (e.g., due to the lack of light at night).

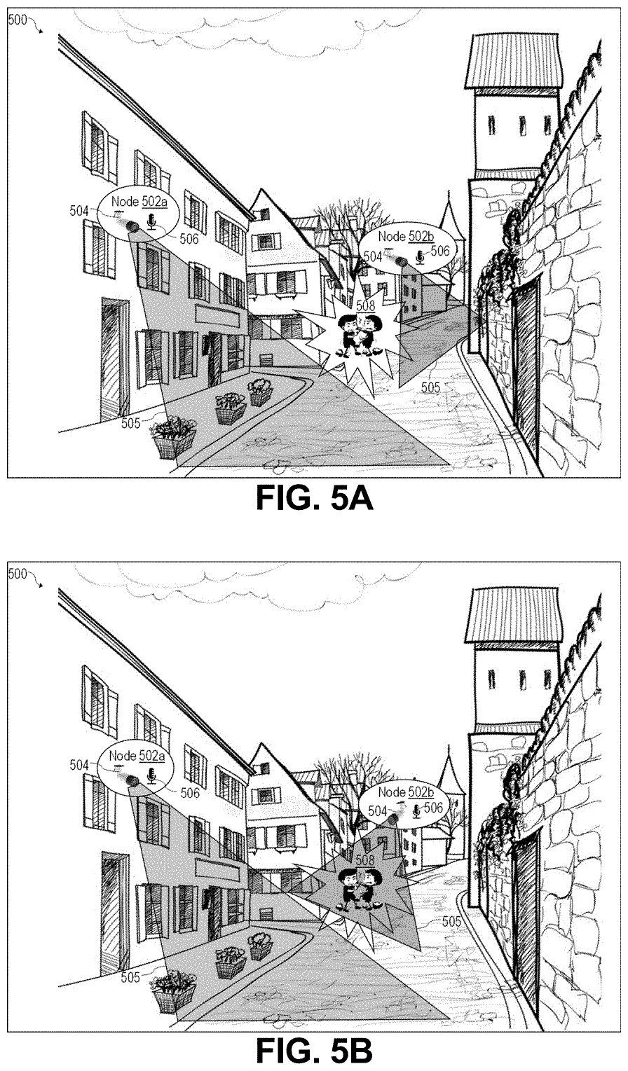

FIGS. 5A-B illustrate an example of a smart city surveillance use case where adaptive multimodal event detection is used to detect fighting. In the illustrated example, an audio-visual multimodality is used to detect fights in a smart city environment 500. Two nodes 502a-b are deployed at different locations in the environment 500, each of which includes a camera 504 and a microphone 506. In some embodiments, for example, each node 502a-b may be a smart camera device with an integrated camera 504 and microphone 506, optionally along with other components (e.g., processing circuitry, wired/wireless communication circuitry).

In the illustrated example, FIG. 5A shows the system configuration when a fighting event 508 first occurs, while FIG. 5B shows the system configuration after it has been dynamically adapted based on the external environment to improve performance.

In FIG. 5A, a fight 508 first breaks out near node 502b. The fight 508 is outside the field of view (FOV) 505 of both cameras 504, which means the cameras 504 are unable to detect the fight 508 (e.g., using a computer vision action recognition artificial intelligence model). However, the microphones 506 of both nodes 502a-b are able to pick up fighting sounds (e.g., screaming/yelling noises). Since the microphone 506 at node 502b is physically closer to the fight 508, it receives audio with a higher amplitude than the microphone 506 at node 502a. As a result, using a sound classification artificial intelligence model, the microphone 506 at node 502b is able to detect the fighting event with a higher confidence level (e.g., 80% confidence) than the microphone 506 at node 502a (e.g., 50% confidence).

In FIG. 5B, the system configuration is dynamically adapted based on the external environment to improve the event detection performance of the respective modalities. For example, based on the conditions of the surrounding environment 500 (e.g., the location of the fighting sounds, the time of day or night), the configuration used for event detection may be intelligently adjusted to achieve more balance between the event detection results of the respective audio and visual modalities (e.g., the audio and visual modalities both detect fighting with high confidence). In some embodiments, the adjusted configuration may include the data ingestion inputs (e.g., sensor configurations), event detection workloads (e.g., prioritizing certain workloads/models, adjusting model performance, swapping out models for specific environments), and/or data fusion weights (e.g., applying a set of weights suitable for low-light conditions at night), among other examples.

In the illustrated example, the microphone 506 at node 502b may localize the direction of sound from the fighting event 508 and coordinate with its associated camera 504. For example, various configuration parameters of the microphone 506 at node 502b may be adjusted to increase the confidence level of the sound classification model, such as the audio beam direction, the audio sampling rate, the microphone sensitivity/gain, and so forth. Further, various configuration parameters of the camera 504 at node 502b may also be adjusted to detect the fighting event with high confidence, such as adjusting the camera field of view 505 in the direction of the fighting event 508, adjusting the lighting intensity to make the video frames clearer for fighting action recognition, and so forth.

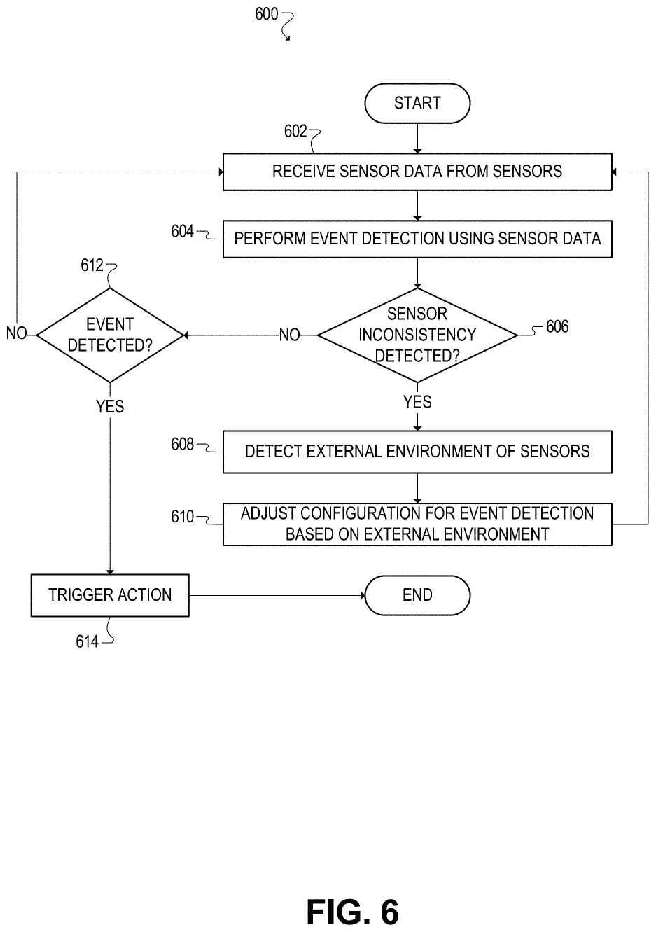

FIG. 6 illustrates a flowchart 600 for performing multi-modal event detection in accordance with certain embodiments. In various embodiments, flowchart 600 may be performed by and/or implemented by any suitable computing devices, platforms, or systems, including those described herein. In some embodiments, for example, flowchart 600 may be performed by and/or implemented by one or more compute nodes in a computing infrastructure. The computing infrastructure may be a distributed computing infrastructure having a variety of compute nodes or devices, such as Internet-of-Things (IoT) devices, smart cameras, edge server appliances, cloud server appliances, etc., along with a variety of sensors either integrated with the compute nodes or otherwise in communication with the compute nodes. In some embodiments, the respective sensors may include or may be used as part of security cameras and surveillance systems, smart city deployments, smart doorbells, smart appliances, mobile phones, autonomous vehicles, robots, and so forth. Each compute node or device in the infrastructure may include some combination of interface circuitry (e.g., I/O interfaces and circuitry, communication circuitry, network interface circuitry), and processing/acceleration circuitry (e.g., processors, cores, central processing units (CPUs), graphics processing units (GPUs), vision processing units (VPUs), FPGA/ASIC accelerators), sensors, and so forth.

The process flow begins at block 602 by receiving, via interface circuitry, sensor data captured by multiple sensors. In various embodiments, the sensors may include at least one of a camera, a microphone, a location sensor, a radio frequency identification (RFID) sensor, a light detection and ranging (LIDAR) sensor, a radio detection and ranging (RADAR) sensor, an ultrasonic sensor, a thermal sensor, an infrared sensor, a temperature sensor, a gas sensor, or a magnetic sensor, among other examples.

The process flow then proceeds to block 604 to perform event detection on the sensor data. For example, one or more workloads may be executed to detect events based on the sensor data captured by the respective sensors, such as performing inference on the sensor data using artificial intelligence and/or machine learning models trained to detect events. In various embodiments, any type of event may be detected depending on the particular use case, such as fighting, criminal activity (e.g., theft), emergencies, manufacturing anomalies, human behavior and emotions (e.g., shopper behavior in retail stores, student behavior in schools, employee behavior at work), vehicle maneuvers (e.g., a car turning or switching lanes), and so forth.

In some embodiments, for example, event detection may be performed on visual data (e.g., images and videos captured by a camera or other vision sensor) using convolutional neural networks (CNN) (e.g., Inception/ResNet CNN architectures, fuzzy CNNs (F-CNN)), among other examples.

In some embodiments, event detection may be performed on audio (e.g., sound captured by a microphone) using transformer models, recurrent neural networks (RNN), long short-term memory (LSTM) networks, and/or CNNs, among other examples.

In some embodiments, event detection may be performed on point clouds captured by LIDAR or RADAR using PointNet architectures and/or clustering (e.g., k-nearest neighbors (kNN), Gaussian mixture models (gMM), k-means clustering, density-based spatial clustering of applications with noise (DBSCAN)), among other examples.

In various embodiments, however, any suitable type and/or combination of artificial intelligence, machine learning, and/or data analysis techniques may be used for event detection and/or other use cases, including, without limitation, artificial neural networks (ANN), deep learning, deep neural networks, convolutional neural networks (CNN) (e.g., Inception/ResNet CNN architectures, fuzzy CNNs (F-CNN)), feed-forward artificial neural networks, multilayer perceptron (MLP), pattern recognition, scale-invariant feature transforms (SIFT), principal component analysis (PCA), discrete cosine transforms (DCT), recurrent neural networks (RNN), long short-term memory (LSTM) networks, transformers, clustering (e.g., k-nearest neighbors (kNN), Gaussian mixture models (gMM), k-means clustering, density-based spatial clustering of applications with noise (DBSCAN)), support vector machines (SVM), decision tree learning (e.g., random forests, classification and regression trees (CART)), gradient boosting (e.g., gradient tree boosting, extreme gradient boosted trees), logistic regression, Bayesian networks, Naïve-Bayes, moving average models, autoregressive moving average (ARMA) models, autoregressive integrated moving average (ARIMA) models, exponential smoothing models, regression analysis models, and/or ensembles thereof (e.g., models that combine the predictions of multiple machine learning models to improve prediction accuracy), among other examples.

The process flow then proceeds to block 606 to determine, based on performing event detection on the sensor data, whether an inconsistency is detected among the sensors. For example, the respective sensors may inconsistently detect or fail to detect an event, the confidence level of a detected event may vary significantly among the sensors, and so forth. In some cases, for example, after performing event detection on the sensor data captured by the respective sensors, an event may be detected based on the sensor data of some sensors, while the event fails to be detected based on the sensor data of other sensors.

The process flow then proceeds to block 608 to detect an external environment of the sensors based on the sensor data. For example, one or more conditions of the external environment may be detected based on the sensor data, such as time of day, lighting, weather, visibility, noise, location, and/or direction (e.g., direction of sound or other activity), among other examples.

The process flow then proceeds to block 610 to adjust one or more configuration parameters used for event detection based on the external environment of the sensors. In some embodiments, the configuration parameters may include sensor settings associated with the sensors, sensor fusion weights indicating the level of influence of the respective sensors for performing event detection, and/or parameters associated with event detection models trained to perform event detection based on the sensor data captured by certain sensors.

In some cases, for example, various sensor settings associated with a camera and/or a microphone may be adjusted based on the external environment. The adjusted camera settings may include pan, tilt, or zoom setting(s) associated with a field of view of the camera, a resolution of the camera, a frame rate of the camera, and/or a lighting intensity of the camera, among other examples. The adjusted microphone settings may include a sensitivity of the microphone, a beam direction of the microphone, and/or a sampling rate of the microphone, among other examples.

Additionally, or alternatively, sensor fusion weights may be adjusted based on the external environment to modify the level of influence of certain sensors when performing event detection. For example, at night, the weights for sensors that are reliable in low-light conditions may be increased (e.g., LIDAR, microphones), while the weights for sensors that are less reliable in those conditions may be decreased (e.g., cameras).

Additionally, or alternatively, certain event detection models used to perform event detection may be reconfigured based on the external environment. In some cases, for example, certain performance characteristics of the event detection models may be adjusted, such as the precision, input data resolution, power efficiency, latency, throughput, accuracy, bandwidth, sampling rate, and/or inference speed, among other examples. Similarly, certain event detection models may be replaced with alternative event detection models that have different performance characteristics. For example, at night, an event detection model for a camera may be replaced with an alternative event detection model trained to perform event detection in low-lighting conditions.

After adjusting the configuration parameters used for event detection, the process flow repeats blocks 602-610 to continue receiving sensor data, performing event detection on the sensor data based on the adjusted configuration parameters, and (re)adjusting the configuration parameters based on the external environment, until the inconsistency among the sensors is resolved at block 606.

Once the inconsistency among the sensors is no longer detected at block 606, the process flow proceeds to block 612 to determine whether an event is detected. In some embodiments, for example, an event may be officially detected or triggered if multiple sensors or modalities detect the event with a confidence level above a particular threshold (e.g., 80% or higher). If an event is not detected, the process flow proceeds back to block 602 to continue receiving sensor data and performing event detection. If an event is detected, however, the process flow proceeds to block 614 to trigger an appropriate action in response to the detected event, such as alerting a user or entity, logging or storing the event, gathering additional information about the event (e.g., performing face detection to identify people involved in the event), triggering a responsive action by a robot (e.g., robots on the manufacturing line, autonomous vehicles such as cars and drones), and/or performing any other responsive or remedial action based on the particular use case.

At this point, the flowchart may be complete. In some embodiments, however, the flowchart may restart and/or certain blocks may be repeated. For example, in some embodiments, the flowchart may restart at block 602 to continue receiving sensor data and performing event detection.

### Example Computing Embodiments

Examples of various computing embodiments that may be used to implement the event detection solution described throughout this disclosure are described below. In particular, any aspects of the solution described in the preceding sections may be implemented using the computing embodiments described below.

### Edge Computing

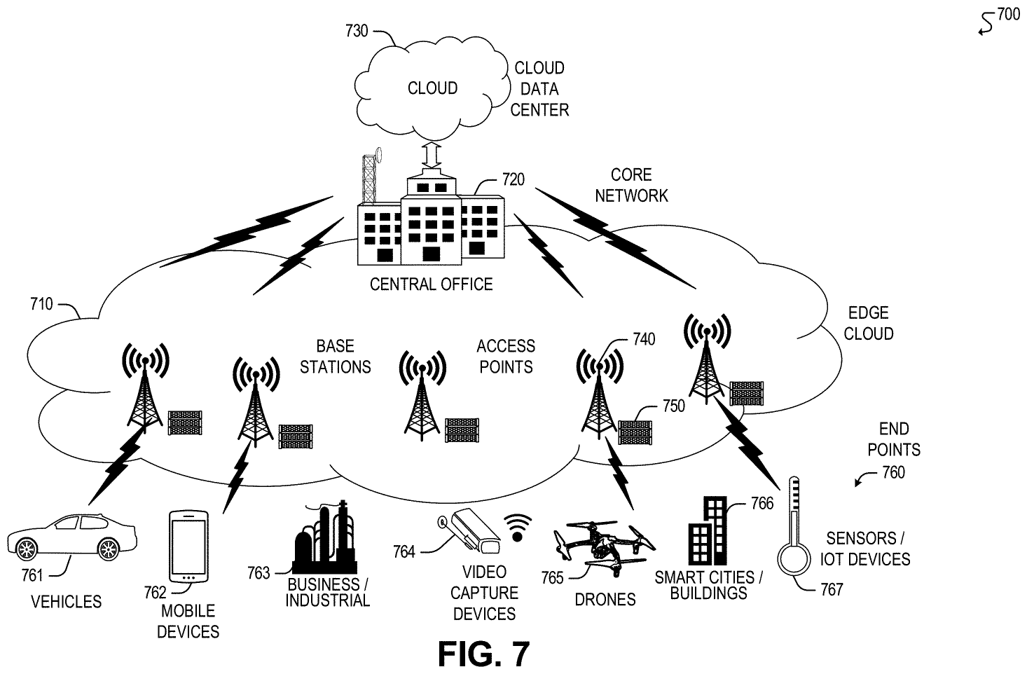

FIG. 7 is a block diagram 700 showing an overview of a configuration for edge computing, which includes a layer of processing referred to in many of the following examples as an “edge cloud”. As shown, the edge cloud 710 is co-located at an edge location, such as an access point or base station 740, a local processing hub 750, or a central office 720, and thus may include multiple entities, devices, and equipment instances. The edge cloud 710 is located much closer to the endpoint (consumer and producer) data sources 760 (e.g., autonomous vehicles 761, user equipment 762, business and industrial equipment 763, video capture devices 764, drones 765, smart cities and building devices 766, sensors and IoT devices 767, etc.) than the cloud data center 730. Compute, memory, and storage resources which are offered at the edges in the edge cloud 710 are critical to providing ultra-low latency response times for services and functions used by the endpoint data sources 760 as well as reduce network backhaul traffic from the edge cloud 710 toward cloud data center 730 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

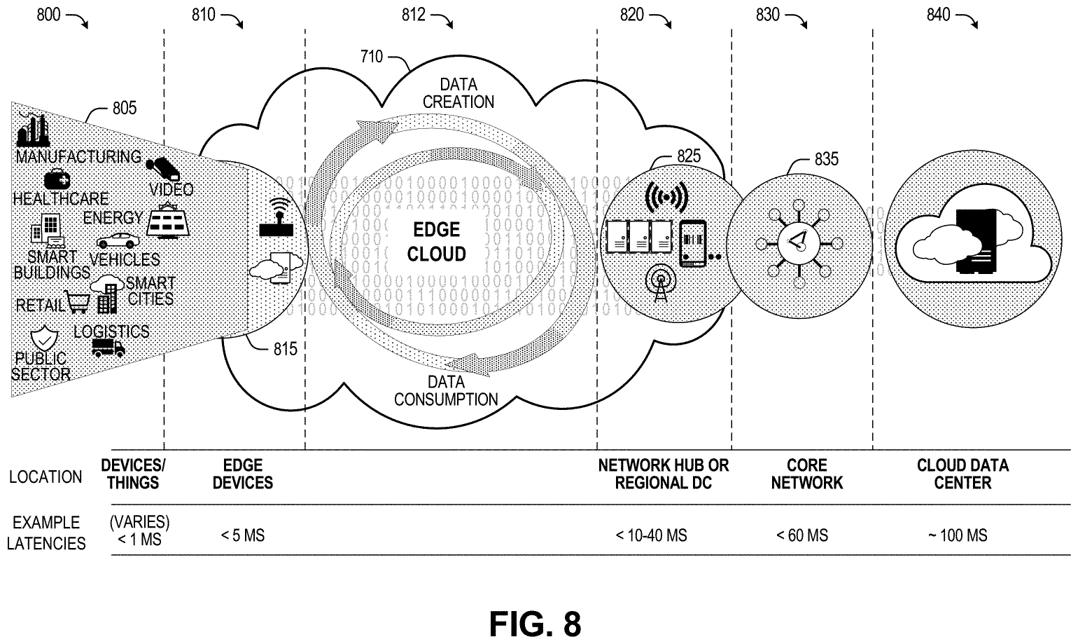

FIG. 8 illustrates operational layers among endpoints, an edge cloud, and cloud computing environments. Specifically, FIG. 8 depicts examples of computational use cases 805, utilizing the edge cloud 710 among multiple illustrative layers of network computing. The layers begin at an endpoint (devices and things) layer 800, which accesses the edge cloud 710 to conduct data creation, analysis, and data consumption activities. The edge cloud 710 may span multiple network layers, such as an edge devices layer 810 having gateways, on-premise servers, or network equipment (nodes 815) located in physically proximate edge systems; a network access layer 820, encompassing base stations, radio processing units, network hubs, regional data centers (DC), or local network equipment (equipment 825); and any equipment, devices, or nodes located therebetween (in layer 812, not illustrated in detail). The network communications within the edge cloud 710 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 800, under 5 ms at the edge devices layer 810, to even between 10 to 40 ms when communicating with nodes at the network access layer 820. Beyond the edge cloud 710 are core network 830 and cloud data center 840 layers, each with increasing latency (e.g., between 50-60 ms at the core network layer 830, to 100 or more ms at the cloud data center layer). As a result, operations at a core network data center 835 or a cloud data center 845, with latencies of at least 50 to 100 ms or more, will not be able to accomplish many time-critical functions of the use cases 805. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 835 or a cloud data center 845, a central office or content data network may be considered as being located within a “near edge” layer (“near” to the cloud, having high latency values when communicating with the devices and endpoints of the use cases 805), whereas an access point, base station, on-premise server, or network gateway may be considered as located within a “far edge” layer (“far” from the cloud, having low latency values when communicating with the devices and endpoints of the use cases 805). It will be understood that other categorizations of a particular network layer as constituting a “close”, “local”, “near”, “middle”, or “far” edge may be based on latency, distance, number of network hops, or other measurable characteristics, as measured from a source in any of the network layers 800-840.

The various use cases 805 may access resources under usage pressure from incoming streams, due to multiple services utilizing the edge cloud. To achieve results with low latency, the services executed within the edge cloud 710 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 710 may provide the ability to serve and respond to multiple applications of the use cases 805 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 710 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 710 (network layers 800-840), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 710.

As such, the edge cloud 710 is formed from network components and functional features operated by and within edge gateway nodes, edge aggregation nodes, or other edge compute nodes among network layers 810-830. The edge cloud 710 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 710 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

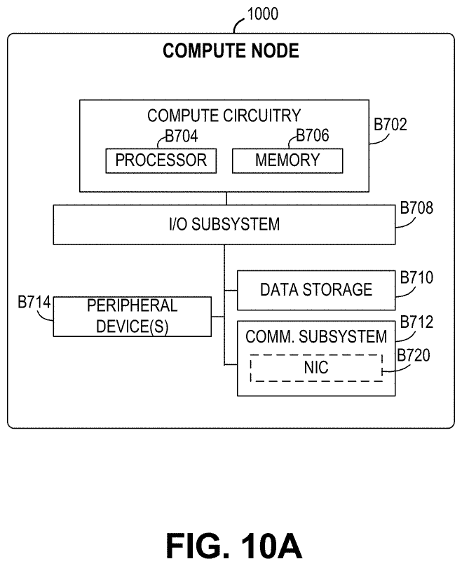

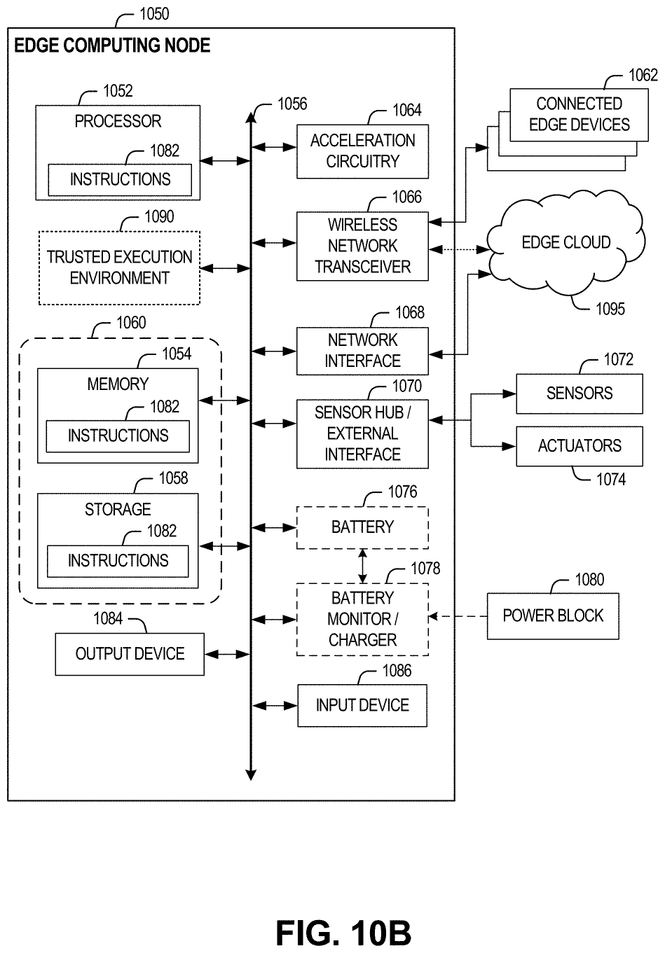

The network components of the edge cloud 710 may be servers, multi-tenant servers, appliance computing devices, and/or any other type of computing devices. For example, the edge cloud 710 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 10B. The edge cloud 710 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

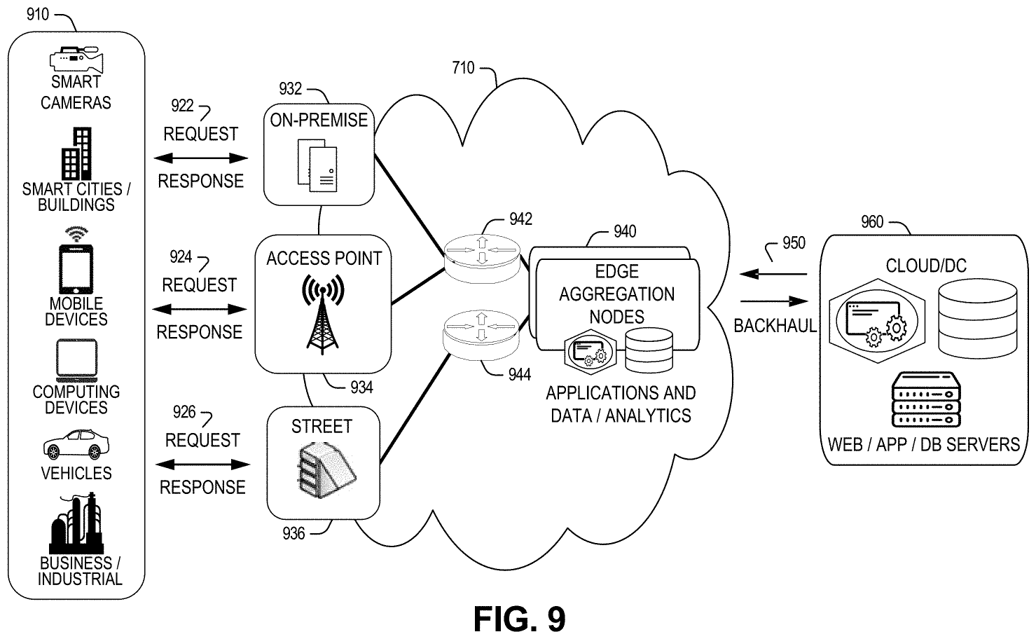

In FIG. 9, various client endpoints 910 (in the form of smart cameras, mobile devices, computers, autonomous vehicles, business computing equipment, industrial processing equipment) exchange requests and responses that are specific to the type of endpoint network aggregation. For instance, client endpoints 910 may obtain network access via a wired broadband network, by exchanging requests and responses 922 through an on-premise network system 932. Some client endpoints 910, such as smart cameras, may obtain network access via a wireless broadband network, by exchanging requests and responses 924 through an access point (e.g., cellular network tower) 934. Some client endpoints 910, such as autonomous vehicles may obtain network access for requests and responses 926 via a wireless vehicular network through a street-located network system 936. However, regardless of the type of network access, the TSP may deploy aggregation points 942, 944 within the edge cloud 710 to aggregate traffic and requests. Thus, within the edge cloud 710, the TSP may deploy various compute and storage resources, such as at edge aggregation nodes 940, to provide requested content. The edge aggregation nodes 940 and other systems of the edge cloud 710 are connected to a cloud or data center 960, which uses a backhaul network 950 to fulfill higher-latency requests from a cloud/data center for websites, applications, database servers, etc. Additional or consolidated instances of the edge aggregation nodes 940 and the aggregation points 942, 944, including those deployed on a single server framework, may also be present within the edge cloud 710 or other areas of the TSP infrastructure.

### Computing Devices and Systems

In further examples, any of the compute nodes or devices discussed with reference to the present edge computing systems and environment may be fulfilled based on the components depicted in FIGS. 10A and 10B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 10A, an edge compute node 1000 includes a compute engine (also referred to herein as “compute circuitry”) 1002, an input/output (I/O) subsystem 1008, data storage 1010, a communication circuitry subsystem 1012, and, optionally, one or more peripheral devices 1014. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1000 may be embodied as any type of engine, device, or collection of devices capable of performing various compute functions. In some examples, the compute node 1000 may be embodied as a single device such as an integrated circuit, an embedded system, a field-programmable gate array (FPGA), a system-on-a-chip (SOC), or other integrated system or device. In the illustrative example, the compute node 1000 includes or is embodied as a processor 1004 and a memory 1006. The processor 1004 may be embodied as any type of processor capable of performing the functions described herein (e.g., executing an application). For example, the processor 1004 may be embodied as a multi-core processor(s), a microcontroller, a processing unit, a specialized or special purpose processing unit, or other processor or processing/controlling circuit.

In some examples, the processor 1004 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 1004 may work in coordination with each other to execute many types of operations and instructions within and on behalf of the compute node 1000.

The memory 1006 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1006 may be integrated into the processor 1004. The memory 1006 may store various software and data used during operation such as one or more applications, data operated on by the application(s), libraries, and drivers.

The compute circuitry 1002 is communicatively coupled to other components of the compute node 1000 via the I/O subsystem 1008, which may be embodied as circuitry and/or components to facilitate input/output operations with the compute circuitry 1002 (e.g., with the processor 1004 and/or the main memory 1006) and other components of the compute circuitry 1002. For example, the I/O subsystem 1008 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1008 may form a portion of a system-on-a-chip (SoC) and be incorporated, along with one or more of the processor 1004, the memory 1006, and other components of the compute circuitry 1002, into the compute circuitry 1002.

The one or more illustrative data storage devices 1010 may be embodied as any type of devices configured for short-term or long-term storage of data such as, for example, memory devices and circuits, memory cards, hard disk drives, solid-state drives, or other data storage devices. Individual data storage devices 1010 may include a system partition that stores data and firmware code for the data storage device 1010. Individual data storage devices 1010 may also include one or more operating system partitions that store data files and executables for operating systems depending on, for example, the type of compute node 1000.

The communication circuitry 1012 may be embodied as any communication circuit, device, or collection thereof, capable of enabling communications over a network between the compute circuitry 1002 and another compute device (e.g., an edge gateway of an implementing edge computing system). The communication circuitry 1012 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1012 includes a network interface controller (NIC) 1020, which may also be referred to as a host fabric interface (HFI). The NIC 1020 may be embodied as one or more add-in-boards, daughter cards, network interface cards, controller chips, chipsets, or other devices that may be used by the compute node 1000 to connect with another compute device (e.g., an edge gateway node). In some examples, the NIC 1020 may be embodied as part of a system-on-a-chip (SoC) that includes one or more processors, or included on a multichip package that also contains one or more processors. In some examples, the NIC 1020 may include a local processor (not shown) and/or a local memory (not shown) that are both local to the NIC 1020. In such examples, the local processor of the NIC 1020 may be capable of performing one or more of the functions of the compute circuitry 1002 described herein. Additionally, or alternatively, in such examples, the local memory of the NIC 1020 may be integrated into one or more components of the client compute node at the board level, socket level, chip level, and/or other levels.

Additionally, in some examples, a respective compute node 1000 may include one or more peripheral devices 1014. Such peripheral devices 1014 may include any type of peripheral device found in a compute device or server such as audio input devices, a display, other input/output devices, interface devices, and/or other peripheral devices, depending on the particular type of the compute node 1000. In further examples, the compute node 1000 may be embodied by a respective edge compute node (whether a client, gateway, or aggregation node) in an edge computing system or like forms of appliances, computers, subsystems, circuitry, or other components.

In a more detailed example, FIG. 10B illustrates a block diagram of an example of components that may be present in an edge computing node 1050 for implementing the techniques (e.g., operations, processes, methods, and methodologies) described herein. This edge computing node 1050 provides a closer view of the respective components of node 1000 when implemented as or as part of a computing device (e.g., as a mobile device, a base station, server, gateway, etc.). The edge computing node 1050 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1050, or as components otherwise incorporated within a chassis of a larger system.

The edge computing device 1050 may include processing circuitry in the form of a processor 1052, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1052 may be a part of a system on a chip (SoC) in which the processor 1052 and other components are formed into a single integrated circuit, or a single package, such as the Edison™ or Galileo™ SoC boards from Intel Corporation, Santa Clara, Calif. As an example, the processor 1052 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1052 and accompanying circuitry may be provided in a single socket form factor, multiple socket form factor, or a variety of other formats, including in limited hardware configurations or configurations that include fewer than all elements shown in FIG. 10B.

The processor 1052 may communicate with a system memory 1054 over an interconnect 1056 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example, the storage 1058 may be implemented via a solid-state disk drive (SSDD). Other devices that may be used for the storage 1058 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1056 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1056 may couple the processor 1052 to a transceiver 1066, for communications with the connected edge devices 1062. The transceiver 1066 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1062. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1066 (or multiple transceivers) may communicate using multiple standards or radios for communications at a different range. For example, the edge computing node 1050 may communicate with close devices, e.g., within about 10 meters, using a local transceiver based on Bluetooth Low Energy (BLE), or another low power radio, to save power. More distant connected edge devices 1062, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1066 (e.g., a radio transceiver) may be included to communicate with devices or services in a cloud (e.g., an edge cloud 1095) via local or wide area network protocols. The wireless network transceiver 1066 may be a low-power wide-area (LPWA) transceiver that follows the IEEE 802.15.4, or IEEE 802.15.4g standards, among others. The edge computing node 1050 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1066, as described herein. For example, the transceiver 1066 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1066 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1068 may be included to provide a wired communication to nodes of the edge cloud 1095 or to other devices, such as the connected edge devices 1062 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to enable connecting to a second network, for example, a first NIC 1068 providing communications to the cloud over Ethernet, and a second NIC 1068 providing communications to other devices over another type of network.

Given the variety of types of applicable communications from the device to another component or network, applicable communications circuitry used by the device may include or be embodied by any one or more of components 1064, 1066, 1068, or 1070. Accordingly, in various examples, applicable means for communicating (e.g., receiving, transmitting, etc.) may be embodied by such communications circuitry.

The edge computing node 1050 may include or be coupled to acceleration circuitry 1064, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1056 may couple the processor 1052 to a sensor hub or external interface 1070 that is used to connect additional devices or subsystems. The devices may include sensors 1072, such as accelerometers, level sensors, flow sensors, optical light sensors, camera sensors, temperature sensors, global navigation system (e.g., GPS) sensors, pressure sensors, barometric pressure sensors, and the like. The hub or interface 1070 further may be used to connect the edge computing node 1050 to actuators 1074, such as power switches, valve actuators, an audible sound generator, a visual warning device, and the like.

In some optional examples, various input/output (I/O) devices may be present within or connected to, the edge computing node 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1050. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1076 may power the edge computing node 1050, although, in examples in which the edge computing node 1050 is mounted in a fixed location, it may have a power supply coupled to an electrical grid, or the battery may be used as a backup or for temporary capabilities. The battery 1076 may be a lithium ion battery, or a metal-air battery, such as a zinc-air battery, an aluminum-air battery, a lithium-air battery, and the like.

A battery monitor/charger 1078 may be included in the edge computing node 1050 to track the state of charge (SoCh) of the battery 1076, if included. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1078 may communicate the information on the battery 1076 to the processor 1052 over the interconnect 1056. The battery monitor/charger 1078 may also include an analog-to-digital (ADC) converter that enables the processor 1052 to directly monitor the voltage of the battery 1076 or the current flow from the battery 1076. The battery parameters may be used to determine actions that the edge computing node 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the edge computing node 1050. A wireless battery charging circuit, such as an LTC4020 chip from Linear Technologies of Milpitas, Calif., among others, may be included in the battery monitor/charger 1078. The specific charging circuits may be selected based on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine-readable medium 1060 including code to direct the processor 1052 to perform electronic operations in the edge computing node 1050. The processor 1052 may access the non-transitory, machine-readable medium 1060 over the interconnect 1056. For instance, the non-transitory, machine-readable medium 1060 may be embodied by devices described for the storage 1058 or may include specific storage units such as optical disks, flash drives, or any number of other hardware devices. The non-transitory, machine-readable medium 1060 may include instructions to direct the processor 1052 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1082 on the processor 1052 (separately, or in combination with the instructions 1082 of the machine readable medium 1060) may configure execution or operation of a trusted execution environment (TEE) 1090. In an example, the TEE 1090 operates as a protected area accessible to the processor 1052 for secure execution of instructions and secure access to data. Various implementations of the TEE 1090, and an accompanying secure area in the processor 1052 or the memory 1054 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1050 through the TEE 1090 and the processor 1052.

### Machine Readable Medium and Distributed Software Instructions

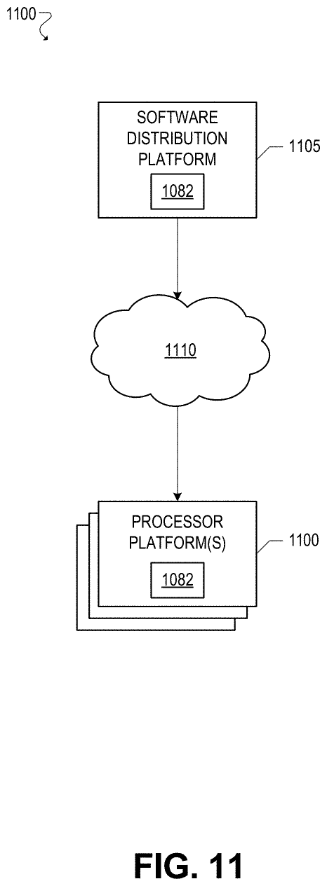

FIG. 11 illustrates an example software distribution platform 1105 to distribute software, such as the example computer readable instructions 1082 of FIG. 10B, to one or more devices, such as example processor platform(s) 1100 and/or example connected edge devices described throughout this disclosure. The example software distribution platform 1105 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 1105). Example connected edge devices may operate in commercial and/or home automation environments. In some examples, a third party is a developer, a seller, and/or a licensor of software such as the example computer readable instructions 1082 of FIG. 10B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 11, the software distribution platform 1105 includes one or more servers and one or more storage devices. The storage devices store the computer readable instructions 1082, which may implement the computer vision pipeline functionality described throughout this disclosure. The one or more servers of the example software distribution platform 1105 are in communication with a network 1110, which may correspond to any one or more of the Internet and/or any of the example networks described throughout this disclosure. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1082 from the software distribution platform 1105. For example, software comprising the computer readable instructions 1082 may be downloaded to the example processor platform(s) 1100 (e.g., example connected edge devices), which is/are to execute the computer readable instructions 1082 to implement the functionality described throughout this disclosure. In some examples, one or more servers of the software distribution platform 1105 are communicatively connected to one or more security domains and/or security devices through which requests and transmissions of the example computer readable instructions 1082 must pass. In some examples, one or more servers of the software distribution platform 1105 periodically offer, transmit, and/or force updates to the software (e.g., the example computer readable instructions 1082 of FIG. 10B) to ensure improvements, patches, updates, etc. are distributed and applied to the software at the end user devices.

In the illustrated example of FIG. 11, the computer readable instructions 1082 are stored on storage devices of the software distribution platform 1105 in a particular format. A format of computer readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer readable instructions 1082 stored in the software distribution platform 1105 are in a first format when transmitted to the example processor platform(s) 1100. In some examples, the first format is an executable binary in which particular types of the processor platform(s) 1100 can execute. However, in some examples, the first format is uncompiled code that requires one or more preparation tasks to transform the first format to a second format to enable execution on the example processor platform(s) 1100. For instance, the receiving processor platform(s) 1100 may need to compile the computer readable instructions 1082 in the first format to generate executable code in a second format that is capable of being executed on the processor platform(s) 1100. In still other examples, the first format is interpreted code that, upon reaching the processor platform(s) 1100, is interpreted by an interpreter to facilitate execution of instructions.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes at least one non-transitory machine-readable storage medium having instructions stored thereon, wherein the instructions, when executed on processing circuitry, cause the processing circuitry to: receive, via interface circuitry, sensor data captured by a plurality of sensors; detect, based on performing event detection on the sensor data, an inconsistency among the sensors; detect, based on the sensor data, an external environment of the sensors; adjust, based on the external environment of the sensors, one or more configuration parameters for event detection; and perform event detection on the sensor data based on the one or more adjusted configuration parameters.

Example 2 includes the storage medium of Example 1, wherein the instructions that cause the processing circuitry to detect, based on performing event detection on the sensor data, the inconsistency among the sensors further cause the processing circuitry to: perform event detection on the sensor data captured by the plurality of sensors; detect an event based on the sensor data captured by a first subset of the sensors; and fail to detect the event based on the sensor data captured by a second subset of the sensors.

Example 3 includes the storage medium of any of Examples 1-2, wherein the instructions that cause the processing circuitry to detect, based on the sensor data, the external environment of the sensors further cause the processing circuitry to: detect, based on the sensor data, one or more conditions of the external environment, wherein the one or more conditions include at least one of lighting, weather, visibility, noise, location, or time of day.

Example 4 includes the storage medium of any of Examples 1-3, wherein: the one or more configuration parameters include one or more sensor settings associated with one or more of the sensors; and the instructions that cause the processing circuitry to adjust, based on the external environment of the sensors, the one or more configuration parameters for event detection further cause the processing circuitry to: adjust, based on the external environment of the sensors, the one or more sensor settings.

Example 5 includes the storage medium of Example 4, wherein: the plurality of sensors include a camera; and the one or more sensor settings include: one or more pan, tilt, or zoom settings associated with a field of view of the camera; a resolution of the camera; a frame rate of the camera; or a lighting intensity of the camera.

Example 6 includes the storage medium of Example 4, wherein: the plurality of sensors include a microphone; and the one or more sensor settings include: a sensitivity of the microphone; a beam direction of the microphone; or a sampling rate of the microphone.

Example 7 includes the storage medium of any of Examples 1-6, wherein: the one or more configuration parameters include one or more sensor fusion weights, wherein the one or more sensor fusion weights indicate a level of influence of one or more of the sensors for performing event detection; and the instructions that cause the processing circuitry to adjust, based on the external environment of the sensors, the one or more configuration parameters for event detection further cause the processing circuitry to: adjust, based on the external environment of the sensors, the one or more sensor fusion weights.

Example 8 includes the storage medium of any of Examples 1-7, wherein: the one or more configuration parameters are associated at least in part with one or more event detection models, wherein the one or more event detection models are trained to perform event detection based on the sensor data captured by one or more of the sensors; and the instructions that cause the processing circuitry to adjust, based on the external environment of the sensors, the one or more configuration parameters for event detection further cause the processing circuitry to: reconfigure, based on the external environment of the sensors, the one or more event detection models used to perform event detection.

Example 9 includes the storage medium of Example 8, wherein the instructions that cause the processing circuitry to reconfigure, based on the external environment of the sensors, the one or more event detection models used to perform event detection further cause the processing circuitry to: adjust, based on the external environment of the sensors, one or more performance characteristics of the one or more event detection models; or replace, based on the external environment of the sensors, the one or more event detection models with one or more alternative event detection models, wherein the one or more alternative event detection models have different performance characteristics than the one or more event detection models.

Example 10 includes the storage medium of any of Examples 1-9, wherein the plurality of sensors include at least one of a camera, a microphone, a location sensor, a radio frequency identification (RFID) sensor, a light detection and ranging (LIDAR) sensor, a radio detection and ranging (RADAR) sensor, an ultrasonic sensor, a thermal sensor, an infrared sensor, a temperature sensor, a gas sensor, or a magnetic sensor.

Example 11 includes a system, comprising: interface circuitry; and processing circuitry to: receive, via the interface circuitry, sensor data captured by a plurality of sensors; detect, based on performing event detection on the sensor data, an inconsistency among the sensors; detect, based on the sensor data, an external environment of the sensors; adjust, based on the external environment of the sensors, one or more configuration parameters for event detection; and perform event detection on the sensor data based on the one or more adjusted configuration parameters.

Example 12 includes the system of Example 11, wherein the processing circuitry to detect, based on the sensor data, the external environment of the sensors is further to: detect, based on the sensor data, one or more conditions of the external environment, wherein the one or more conditions include at least one of lighting, weather, visibility, noise, location, or time of day.

Example 13 includes the system of any of Examples 11-12, wherein: the one or more configuration parameters include one or more sensor settings associated with one or more of the sensors; and the processing circuitry to adjust, based on the external environment of the sensors, the one or more configuration parameters for event detection is further to: adjust, based on the external environment of the sensors, the one or more sensor settings.

Example 14 includes the system of Example 13, wherein: the plurality of sensors include a camera; and the one or more sensor settings include: one or more pan, tilt, or zoom settings associated with a field of view of the camera; a resolution of the camera; a frame rate of the camera; or a lighting intensity of the camera.

Example 15 includes the system of Example 13, wherein: the plurality of sensors include a microphone; and the one or more sensor settings include: a sensitivity of the microphone; a beam direction of the microphone; or a sampling rate of the microphone.

Example 16 includes the system of any of Examples 11-15, wherein: the one or more configuration parameters include one or more sensor fusion weights, wherein the one or more sensor fusion weights indicate a level of influence of one or more of the sensors for performing event detection; and the processing circuitry to adjust, based on the external environment of the sensors, the one or more configuration parameters for event detection is further to: adjust, based on the external environment of the sensors, the one or more sensor fusion weights.

Example 17 includes the system of any of Examples 11-16, wherein: the one or more configuration parameters are associated at least in part with one or more event detection models, wherein the one or more event detection models are trained to perform event detection based on the sensor data captured by one or more of the sensors; and the processing circuitry to adjust, based on the external environment of the sensors, the one or more configuration parameters for event detection is further to: reconfigure, based on the external environment of the sensors, the one or more event detection models used to perform event detection.

Example 18 includes the system of Example 17, wherein the processing circuitry to reconfigure, based on the external environment of the sensors, the one or more event detection models used to perform event detection is further to: adjust, based on the external environment of the sensors, one or more performance characteristics of the one or more event detection models; or replace, based on the external environment of the sensors, the one or more event detection models with one or more alternative event detection models, wherein the one or more alternative event detection models have different performance characteristics than the one or more event detection models.

Example 19 includes a method, comprising: receiving, via interface circuitry, sensor data captured by a plurality of sensors; detecting, based on performing event detection on the sensor data, an inconsistency among the sensors; detecting, based on the sensor data, an external environment of the sensors; adjusting, based on the external environment of the sensors, one or more configuration parameters for event detection; and performing event detection on the sensor data based on the one or more adjusted configuration parameters.

Example 20 includes the method of Example 19, wherein adjusting, based on the external environment of the sensors, the one or more configuration parameters for event detection comprises: adjusting, based on the external environment of the sensors: one or more sensor settings associated with one or more of the sensors; one or more sensor fusion weights, wherein the one or more sensor fusion weights indicate a level of influence of one or more of the sensors for performing event detection; or one or more performance characteristics of one or more event detection models, wherein the one or more event detection models are trained to perform event detection based on the sensor data captured by one or more of the sensors.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

1. At least one non-transitory machine-readable storage medium having instructions stored thereon, wherein the instructions, when executed on processing circuitry, cause the processing circuitry to:
receive, via interface circuitry, sensor data captured by a plurality of sensors;
detect, based on performing event detection on the sensor data, an inconsistency among the sensors;
detect, based on the sensor data, an external environment of the sensors;
adjust, based on the external environment of the sensors, one or more configuration parameters for event detection; and
perform event detection on the sensor data based on the one or more adjusted configuration parameters.

2. The storage medium of claim 1, wherein the instructions that cause the processing circuitry to detect, based on performing event detection on the sensor data, the inconsistency among the sensors further cause the processing circuitry to:
perform event detection on the sensor data captured by the plurality of sensors;
detect an event based on the sensor data captured by a first subset of the sensors; and
fail to detect the event based on the sensor data captured by a second subset of the sensors.

3. The storage medium of claim 1, wherein the instructions that cause the processing circuitry to detect, based on the sensor data, the external environment of the sensors further cause the processing circuitry to:
detect, based on the sensor data, one or more conditions of the external environment, wherein the one or more conditions include at least one of lighting, weather, visibility, noise, location, or time of day.

4. The storage medium of claim 1, wherein:
the one or more configuration parameters include one or more sensor settings associated with one or more of the sensors; and
the instructions that cause the processing circuitry to adjust, based on the external environment of the sensors, the one or more configuration parameters for event detection further cause the processing circuitry to:
adjust, based on the external environment of the sensors, the one or more sensor settings.

5. The storage medium of claim 4, wherein:
the plurality of sensors include a camera; and
the one or more sensor settings include:
one or more pan, tilt, or zoom settings associated with a field of view of the camera;
a resolution of the camera;
a frame rate of the camera; or
a lighting intensity of the camera.

6. The storage medium of claim 4, wherein:
the plurality of sensors include a microphone; and
the one or more sensor settings include:
a sensitivity of the microphone;
a beam direction of the microphone; or
a sampling rate of the microphone.

7. The storage medium of claim 1, wherein:
the one or more configuration parameters include one or more sensor fusion weights, wherein the one or more sensor fusion weights indicate a level of influence of one or more of the sensors for performing event detection; and
the instructions that cause the processing circuitry to adjust, based on the external environment of the sensors, the one or more configuration parameters for event detection further cause the processing circuitry to:
adjust, based on the external environment of the sensors, the one or more sensor fusion weights.

8. The storage medium of claim 1, wherein:
the one or more configuration parameters are associated at least in part with one or more event detection models, wherein the one or more event detection models are trained to perform event detection based on the sensor data captured by one or more of the sensors; and
the instructions that cause the processing circuitry to adjust, based on the external environment of the sensors, the one or more configuration parameters for event detection further cause the processing circuitry to:
reconfigure, based on the external environment of the sensors, the one or more event detection models used to perform event detection.

9. The storage medium of claim 8, wherein the instructions that cause the processing circuitry to reconfigure, based on the external environment of the sensors, the one or more event detection models used to perform event detection further cause the processing circuitry to:
adjust, based on the external environment of the sensors, one or more performance characteristics of the one or more event detection models; or
replace, based on the external environment of the sensors, the one or more event detection models with one or more alternative event detection models, wherein the one or more alternative event detection models have different performance characteristics than the one or more event detection models.

10. The storage medium of claim 1, wherein the plurality of sensors include at least one of a camera, a microphone, a location sensor, a radio frequency identification (RFID) sensor, a light detection and ranging (LIDAR) sensor, a radio detection and ranging (RADAR) sensor, an ultrasonic sensor, a thermal sensor, an infrared sensor, a temperature sensor, a gas sensor, or a magnetic sensor.

11. A system, comprising:
interface circuitry; and
processing circuitry to:
receive, via the interface circuitry, sensor data captured by a plurality of sensors;
detect, based on performing event detection on the sensor data, an inconsistency among the sensors;
detect, based on the sensor data, an external environment of the sensors;
adjust, based on the external environment of the sensors, one or more configuration parameters for event detection; and
perform event detection on the sensor data based on the one or more adjusted configuration parameters.

12. The system of claim 11, wherein the processing circuitry to detect, based on the sensor data, the external environment of the sensors is further to:
detect, based on the sensor data, one or more conditions of the external environment, wherein the one or more conditions include at least one of lighting, weather, visibility, noise, location, or time of day.

13. The system of claim 11, wherein:
the one or more configuration parameters include one or more sensor settings associated with one or more of the sensors; and
the processing circuitry to adjust, based on the external environment of the sensors, the one or more configuration parameters for event detection is further to:
adjust, based on the external environment of the sensors, the one or more sensor settings.

14. The system of claim 13, wherein:
the plurality of sensors include a camera; and
the one or more sensor settings include:
one or more pan, tilt, or zoom settings associated with a field of view of the camera;
a resolution of the camera;
a frame rate of the camera; or
a lighting intensity of the camera.

15. The system of claim 13, wherein:
the plurality of sensors include a microphone; and
the one or more sensor settings include:
a sensitivity of the microphone;
a beam direction of the microphone; or
a sampling rate of the microphone.

16. The system of claim 11, wherein:
the one or more configuration parameters include one or more sensor fusion weights, wherein the one or more sensor fusion weights indicate a level of influence of one or more of the sensors for performing event detection; and
the processing circuitry to adjust, based on the external environment of the sensors, the one or more configuration parameters for event detection is further to:
adjust, based on the external environment of the sensors, the one or more sensor fusion weights.

17. The system of claim 11, wherein:
the one or more configuration parameters are associated at least in part with one or more event detection models, wherein the one or more event detection models are trained to perform event detection based on the sensor data captured by one or more of the sensors; and
the processing circuitry to adjust, based on the external environment of the sensors, the one or more configuration parameters for event detection is further to:
reconfigure, based on the external environment of the sensors, the one or more event detection models used to perform event detection.

18. The system of claim 17, wherein the processing circuitry to reconfigure, based on the external environment of the sensors, the one or more event detection models used to perform event detection is further to:
adjust, based on the external environment of the sensors, one or more performance characteristics of the one or more event detection models; or
replace, based on the external environment of the sensors, the one or more event detection models with one or more alternative event detection models, wherein the one or more alternative event detection models have different performance characteristics than the one or more event detection models.

19. A method, comprising:
receiving, via interface circuitry, sensor data captured by a plurality of sensors;
detecting, based on performing event detection on the sensor data, an inconsistency among the sensors;
detecting, based on the sensor data, an external environment of the sensors;
adjusting, based on the external environment of the sensors, one or more configuration parameters for event detection; and
performing event detection on the sensor data based on the one or more adjusted configuration parameters.

20. The method of claim 19, wherein adjusting, based on the external environment of the sensors, the one or more configuration parameters for event detection comprises:
adjusting, based on the external environment of the sensors:
one or more sensor settings associated with one or more of the sensors;
one or more sensor fusion weights, wherein the one or more sensor fusion weights indicate a level of influence of one or more of the sensors for performing event detection; or
one or more performance characteristics of one or more event detection models, wherein the one or more event detection models are trained to perform event detection based on the sensor data captured by one or more of the sensors.
